(19) United States
(12) Patent Application Publication
(10) Pub. No.: US 2005/0102634 A1
(43) Pub. Date: May 12, 2005

(54) Understandable navigation of an information array

(76) Inventor: David Hendler Sloo, Menlo Park, CA (US)

Correspondence Address: LEE & HAYES PLLC, 421 W RIVERSIDE AVENUE SUITE 500, SPOKANE, WA, 99201, US

(21) Appl. No.: 10/705,068

(22) Filed: Nov. 10, 2003

(51) Int. Cl. G06F 3/00; H04N 5/445

(52) U.S. Cl. 715/823; 715/860; 715/859; 715/816; 715/739; 715/783; 715/810; 725/39; 725/52

(57) ABSTRACT

To prevent disorientation, the described systems and methods continuously maintain a visual landmark during electronic navigation of a one-dimensional list of items or a two-dimensional information grid in situations where only a part of the list or the information grid is displayed at a given time. In one implementation, an electronic program guide is dynamically scaled to maintain visibility of a navigation starting point during browsing with rudimentary navigation controls, but reverts back to a legible scale when navigation stops.

### TECHNICAL FIELD

The subject matter relates generally to information display systems and more specifically to understandable navigation of an information array.

### BACKGROUND

Computer and television menus continue to offer more selection options within smaller viewing windows on a computer monitor or television screen. Likewise, program guides for video content available on television also continue to grow, with some systems anticipating thousands of broadcast channels from which to list and select content. As the amount of menu content and program guide content increase, current menus and electronic program guides (EPGs) that list more TV channels over longer time periods become increasingly difficult to navigate. For example, scrolling menu contents that do not fit within a viewing window or scrolling a two-dimensional channel/time grid becomes difficult for many computer and television products that use rudimentary and unsophisticated controls to perform the navigation, such as remote controllers with four or even just two direction keys.

Multimedia users may become disoriented while navigating a large EPG grid through a display window that does not show the entire grid. As the user moves across the grid, using a conventional scrolling mechanism, the data on the screen changes rapidly. If the user is not watching the display carefully or if the EPG information moves too quickly across the screen, then the user's eye may not be able to track and estimate how far the scrolling has taken the user from an initial starting point. In other words, conventional scrolling of large EPG grids relies a great deal on a user keeping track of how much of the displayed information has moved within the limited viewing window. Consequently, it is easy to lose track of the context of EPG information currently being displayed in a window of limited area.

### SUMMARY

To prevent disorientation, the described systems and methods continuously maintain a visual landmark during electronic navigation of a one-dimensional list of items or a two-dimensional information grid in situations where only a part of the list or the information grid is displayed at a given time. In one implementation, an electronic program guide is dynamically scaled to maintain visibility of a navigation starting point during browsing with rudimentary navigation controls, but reverts back to a legible scale when navigation stops.

### BRIEF DESCRIPTION OF THE DRAWINGS

FIG. 1 is a graphic representation of an exemplary system for oriented navigation of an information array.

FIG. 2 is a block diagram of an exemplary navigation orientation engine.

FIG. 3 is a graphic representation of an exemplary technique for scaling an information grid to maintain a visual landmark.

FIG. 4 is a graphic representation of an exemplary technique for reverting to a previous scaling size to provide legibility of information in a scaled information grid.

FIG. 5 is a graphic representation of an exemplary technique for using a grid edge as a navigation landmark.

FIG. 6 is a graphic representation of an exemplary technique for placing an arbitrary visual edge in an information grid for a navigation landmark.

FIG. 7 is a graphic representation of an exemplary technique for marking channels that have a theme as a navigation landmark.

FIG. 8 is a graphic representation of an exemplary technique of adding contour markings to an information grid as a navigation landmark.

FIG. 9 is a flow diagram of an exemplary method of maintaining a visual landmark during navigation.

FIG. 10 is a flow diagram of an exemplary method of scaling an information grid to maintain a focused entry as a navigation landmark and reverting to a legible scaling size when navigation stops.

### DETAILED DESCRIPTION

Overview

Many computer and television products use limited directional navigation operators, such as four-button remote controllers, trackballs, game-rocker pads, and joysticks. These rudimentary and limited electronic navigation controls allow unsophisticated navigation of information arrays that are larger than can ordinarily fit on the canvas of a screen, display pane, or window of limited viewing area (“display”). The subject matter describes exemplary techniques for continuously landmarking scrolled information so that a viewer maintains orientation within a list or a two-dimensional array (“grid”) while viewing only a small part of the list or grid.

In one implementation, an exemplary technique magnifies or zooms (“scales”) displayed information, such as television electronic program guide (EPG) listings. As a user moves a “selection” box or highlight from a first entry to a second entry, that is, form a first program listing to a second program listing, exemplary dynamic scaling automatically changes the size of the displayed information so that both the first program listing and the second program listing always remain visible within the display. In the fixed display area of a viewing window, more of the EPG grid may be shown at a lower magnification in order to keep displaying both the first program listing that was the starting point for navigation and the second program listing that has been arrived at as the current focus of navigation. Thus, the first program listing that provided the navigational starting point is retained as a visual landmark as the user scrolls.

In one implementation, after dynamic scaling has occurred, an exemplary technique monitors navigational input and reverts back to an original larger scaling size to assure legible information if a threshold amount of time passes with no further navigational input.

Additional landmarks, for maintaining user orientation during navigation may be selected as well, such as an edge or corner of an EPG grid, a color coded program listing, and/or added mileposts, such as inserted grids and contour lines.

In contrast to conventional manual “zoom controls” used in Web-based mapping interfaces, an exemplary technique requires only two to four direction keys available on conventional TV remote controllers to operate. Thus, the subject matter is also applicable to kiosks, in-car maps, spreadsheets, etc., for which alternate input devices could be used with the invention, such as trackballs, joysticks, touchpads, etc. Of course, the subject matter works with more sophisticated navigation controls as well, such as with a keyboard and mouse.

Exemplary System

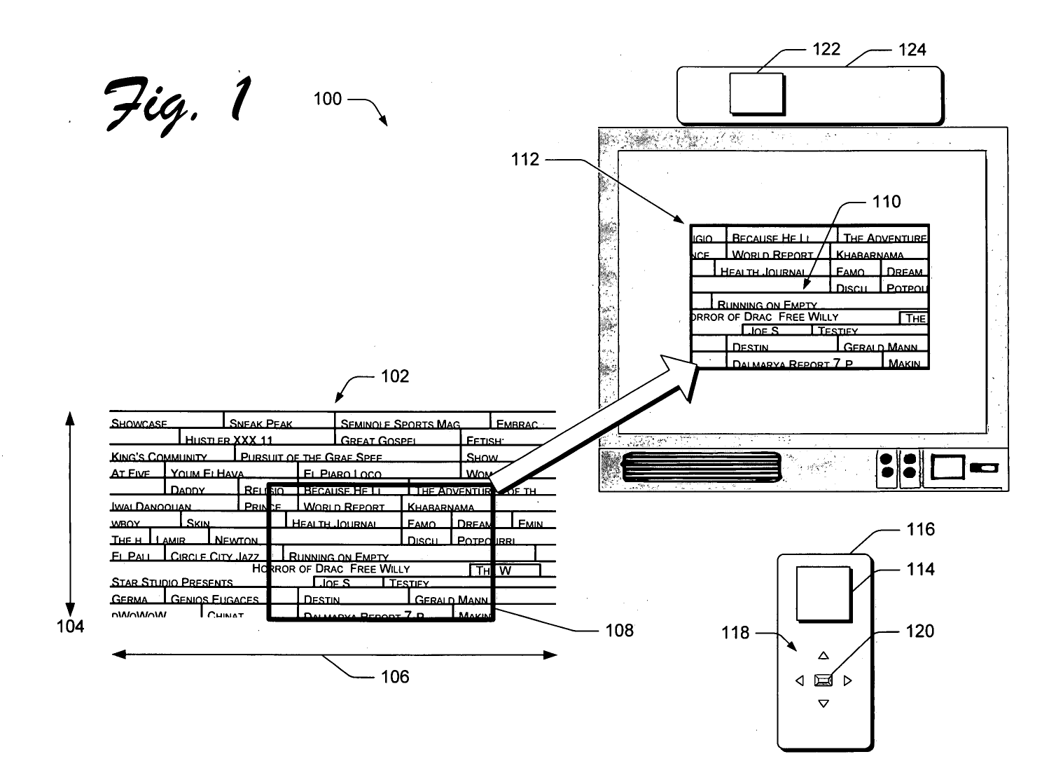

As shown in FIG. 1, using the context of an EPG grid as an example, an exemplary system 100 accesses and/or generates an EPG grid 102, that has a channel axis 104 plotted against a time axis 106. The exemplary system 100 displays only a limited part 108 of the EPG grid 102 as “displayed EPG information” 110 on a display area 112 (such as a television screen, computer window, pane, viewport, and/or the EPG information display 114 of a TV remote controller 116). The display area 112 is not large enough to legibly show the entire EPG grid 102 if the EPG grid 102 is large. If reduced enough in size, a large EPG grid 102 may be visible in its entirety in a display area 112, but the text in the reduced EPG grid 102 is then typically too small to read. The smaller the display area 112, of course, the less information from the EPG grid 102 can be shown at any one time.

Because EPG grids 102 typically contain more information than a display area 112 can legibly reveal, a user must scroll displayed EPG information 110 across and up and down the display area 112 to see information that is off-screen, much as one would view part of a large panorama through a “pinhole,” “viewport,” or binoculars.

On computer equipment, there may be relatively sophisticated mechanisms available to perform manual or automatic scrolling and other navigation, but as noted above, on many multimedia systems, such as television systems that use remote controllers 116, only four direction keys 118 are usually provided for scrolling displayed EPG information 110. An “enter” or “selection” key 120 may also be provided with the four direction keys 118.

In an exemplary system 100, only a single program listing within displayed EPG information 110 is focused at any given moment and designated, for example, by using a selection box, highlight, and/or cursor over the program listing or in the same grid cell as the program listing. When the direction keys 118 move the focus to an adjacent program listing and the adjacent program listing is outside the display area 112, an exemplary application or exemplary navigation orientation engine 122 rewrites the display area 112 with displayed EPG information 110 at a different magnification that includes the adjacent program listing that was off-screen, i.e., the displayed EPG information 110 changes size as it scrolls.

An exemplary application or an exemplary navigation orientation engine 122 may reside in a television set-top box 124, in a computing device, in a digital video recorder, in a remote controller 116, or in other devices that display part of a two-dimensional information array.

Exemplary Engine

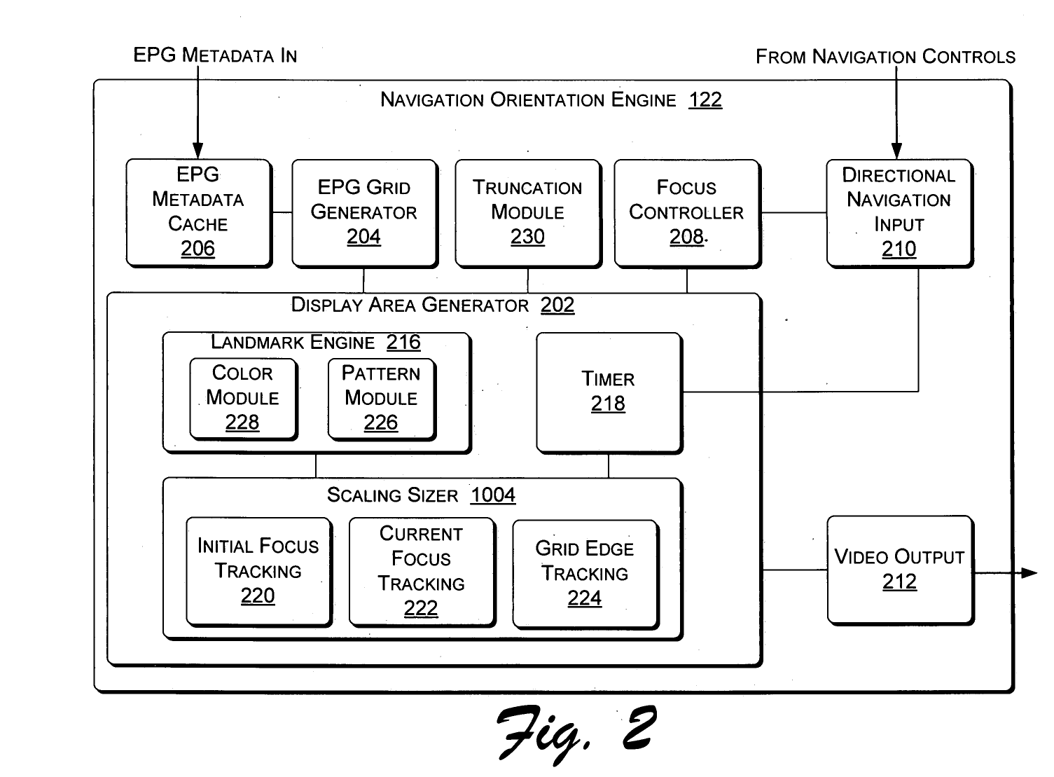

FIG. 2 shows the exemplary navigation orientation engine 122 of FIG. 1 in greater detail. A display area generator 202, EPG grid generator 204, EPG metadata cache 206, focus controller 208, directional navigation input 210, and video output 212 are communicatively coupled as illustrated. The display area generator 202 may further include a scaling sizer 214, a landmark engine 216, and a timer 218, communicatively coupled as illustrated. The scaling sizer 214 may further include an initial focus tracking module 220, a current focus tracking module 222, and a grid edge tracking module 224. The landmark engine 216 may further include a color module 226 and a pattern module 228.

EPG metadata can arrive at the EPG metadata cache 206 from a broadcaster, content provider, or headend, in various formats, such an extensible markup language file. The EPG grid generator 204 unpacks, sorts, and/or refines the EPG metadata, if necessary into a channel/time EPG grid 102 intelligible to the rest of the navigation orientation engine 122. In some implementations, an EPG metadata cache 206 and/or an EPG grid generator 204 may be optional if the EPG metadata is in a compatible format for the display area generator 202.

The display area generator 202 produces a visual window, a pane, or a screen region of known size or proportion that includes displayed EPG information 110 and sends the display area information as a video signal to the video output 212. That is, the display area generator 202 is programmed or communicatively coupled to know the (fixed) area or region of display area 112—e.g., TV screen canvas or computer monitor window, etc.—in which displayed EPG information 110 will be made viewable. The display area generator 202 determines which limited part 108 of an EPG grid 102 will be used as displayed EPG information 110. Thus, with the assistance of its associated scaling sizer 214, the display area generator 202 determines the horizontal and vertical coordinates and size of a limited part 108 of an EPG grid 102 to post to the display area 112. The focus controller 208 may inform the display area generator 202 of a changing focus, that is, which current program listing to highlight during navigation by a user.

The scaling sizer 214 associated with the display area generator 202 selects a limited part 108 of an EPG grid 102 and writes the limited part 108 into the usually fixed display area 112. If a relatively small part 108 of an EPG grid 102 is selected for display, then the displayed EPG information 110 appears relatively large in the fixed display area 112. If a relatively large limited part 108 of an EPG grid 102 is selected for display, then the displayed EPG information 110 appears relatively small in the fixed display area 112, although there will be more information—but reduced in visual size. In other words, the scaling sizer 214 can visually magnify or reduce the displayed EPG information 110.

In one implementation, the scaling sizer 214 bases a scaling size for displayed EPG information 110 on the relative locations of an initially focused program listing and a finally focused program listing, i.e., the finally focused program listing is the program listing that is currently highlighted after some scrolling. The initial focus tracking module 220 keeps track of the initially focused program listing and the current focus tracking module 222 keeps track of the final (or current) focused program listing. Under a current scaling size, when the scrolling distance between the initially focused program listing and the finally focused program listing is greater than the respective horizontal or vertical dimension of the display area 112, the scaling sizer changes the scale of the displayed EPG information 110, so that both the initially and finally focused program listings remain viewable in the display area 112. Thus, an mentioned, the initially focused program listing can be thought of as a visual landmark for maintaining orientation during the scrolling.

The scaling sizer 214 may also base a scaling size on the proximity of an EPG grid edge to a focused program listing, as monitored by the grid edge tracking module 224. Thus, if an EPG grid edge (502) would provide orientation during navigation, the scaling sizer might scale the displayed EPG information 110 so that the EPG grid edge (502) is visible in the display area 112.

If the scaling sizer 214 has rescaled the displayed EPG information 110 to a magnification at which the program listings are difficult to read, than after a time interval of no scrolling (as measured by the timer 218 sensing no input from the directional navigation input 210), the scaling sizer 214 may revert to a scaling size in which the program listings appear larger and easier to read. In one implementation, the currently focused program listing becomes an anchor point for a reversion to a larger scale in which the magnification pushes some of the displayed EPG information 110 out of the display area 112. That is, the previous initially focused program listing, which provided the visual landmark during navigation, may drop off the screen if the displayed EPG information 110 reverts to a larger font size. The currently focused program listing then becomes the landmark for subsequent navigation.

The scaling sizer 214 may also use characteristics of the user input stream from the directional navigation input 210 to determine what scale to apply. For example, if the user rapidly applies the same directional input, the scaling sizer may select a lower magnification so that more of displayed EPG information 110 fits on the screen.

The landmark engine 216 may generate additional orientation cues. The color module 226 may add color to similar programs listings or certain channels, or produce an artificial grid or grid artifact to aid navigation. The pattern module 228 may impose a design for the addition of color or other markings. For example, “contour lines” consisting of color and/or a crosshatching design can be applied in a pattern of concentric rectangles radiating from an initially focused program listing. The contour lines provide navigation milestones as scrolling proceeds away from the initially focused program listing.

Finally, a truncation module 230 associated with the display area generator 202 cuts off the end of program listings if the words in a program listing do not fit in a reduced grid cell size. Likewise, the truncation module 230 may cut off the bottoms of the words making up the program listings. In other words, the display area generator 202 can apply a larger font to program listings than would be proportional to some grid size reductions effected by rescaling. According to one aspect of the subject matter, text for program listings that has been clipped at the end and at the bottom is often more legible than intact text that has been reduced in proportion to grid size reduction—i.e., the truncation module 230 uses a disproportionately large font that has been truncated and/or clipped to enhance program listing legibility during scaling.

Exemplary Techniques

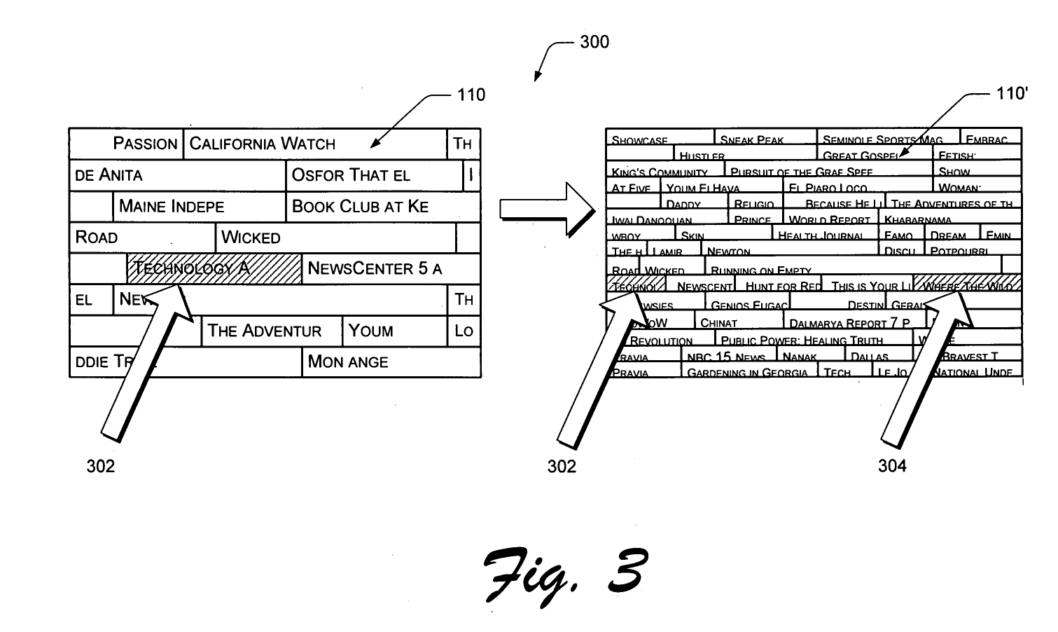

FIG. 3 illustrates an exemplary technique 300 of maintaining a visual landmark on a two-dimensional EPG grid 102 during navigation. When scrolling is about to commence, the displayed EPG information 110 in a display area 112 is already scaled to a certain visual size, usually selected to provide legibility of the program listings. A first program listing 302 may be highlighted as the current focus by a selection box, color, or cursor. The first program listing 302 provides a starting point for navigation, that is, movement through the program listings to be imparted by the direction keys 118. It should be noted that when a program listing is in focus, i.e., highlighted, a selection key 120 may also end the navigational browsing by playing the program associated with the program listing; entering the program listing into an application; or displaying guide information for the selected program listing. Thus, selection of a focused program listing may “change the channel” to that program, or may perform more complex operations using the selected program listing.

In one implementation of exemplary scrolling, the first program listing 302 remains visible as a visual landmark on the canvas of the display area 112 even when the direction keys 118 move the focus to a second program listing 304 far on the EPG grid 102 from the first program listing 302. This maintenance of a visual landmark is accomplished by scaling the size of the displayed EPG information 110′ within the display area 112. If each press of a direction key 118 moves a focus by an increment of one grid cell space, then in FIG. 3 the focus moves four cell spaces horizontally from the first program listing 302 to the second program listing 304. When the focus reaches the far side of the display area 112, an exemplary application or an exemplary navigation orientation engine 122 scales the size of the displayed EPG information 110 to show more of the EPG grid 102, i.e., at a lower magnification. This “zooming out” allows the first program listing 302 to remain visible while displaying the second program listing 304. The scaling thus provides orientation during scrolling by keeping the point of origin of the exemplary scrolling visible on the display area 112. The displayed EPG information 110, 110′ may be rescaled multiple times during navigation to retain the first program listing 302 as a visible landmark in the display area 112.

In some implementations, the first program listing 302 remains highlighted to accentuate the point of origin of the scrolling, even though the first program listing 302 is not the current focus.

In one aspect of the subject matter, when scaling is executed in order to keep a first program listing 302 visible as an orientation landmark on a display area 112, the text of the program listing may become illegible due to small size. In one implementation, as noted above with respect to the truncation module 230, the ends and/or bottoms of the alphanumeric characters making up the text of the program listings is clipped, as illustrated for the displayed EPG information 110′. This truncation allows relatively large text fonts to be used in relatively small grid cells that have been reduced in size due to scaling. Even when approximately the entire bottom half of the text of the program listings has been clipped, the program listing are generally still legible and intelligible. Likewise, truncation of the end of a program listing often leaves the program listing understandable, for example, “The West Wi” would be widely recognizable as the TV program, “The West Wing.”

More scaling of the displayed EPG information (110, 110′) typically occurs when a user is scrolling in left-to-right or right-to-left directions along a time axis 106 of a given channel on the EPG grid 102 than when a user is scrolling in up-and-down directions across channels on the channel axis 104 because EPG grid cells are usually much longer than they are high. Aspect ratios of most TV screens do not compensate enough for this disparity to successfully equalize scaling applied when scrolling along the two different axes.

In one implementation, the displayed EPG information 110 is rescaled just enough to bring the next off-screen program listing into the display area 112. In this implementation, a minor rescaling is likely to occur with every actuation of a direction key 118 that furthers the navigational movement in the same direction as the previous movement.

In another implementation, when the display area 112 is to be rescaled, only certain predetermined magnifications of an EPG grid 102 are used. When a focus reaches an edge of the display area 112, the scaling of the displayed EPG information 110 changes to a magnification that may result in a much larger piece of the EPG grid 102 being displayed than was displayed before the scaling. After the relatively large change in scaling, navigation can take place across multiple EPG grid cells before scrolling movement again brings the focus to an edge of the display area 112, necessitating another rescaling.

In some implementations, the achieved scale of displayed EPG information 110′ remains constant once a user stops using navigation controls, such as the direction keys 118. If text is illegible, due to small size, the user may take some action, such as pressing a selection key 120 to rescale the EPG grid 102 to a legible text size, maintaining the newly focused second program listing 304 within the display area 112. If no selection key 120 is actuated and scrolling resumes, then the resealing of displayed EPG information 110 may continue as further movement proceeds: if the user navigates back toward the first program listing 302 then the magnification of the EPG grid 102 may reverse and rescale back to an original higher magnification proportional to the distance from the first program listing 302. If the user navigates further away from the first program listing 302, then the magnification of the EPG grid 102 may continue to reach lower and lower values, showing more and more of the EPG grid 102 and smaller and smaller program listing text to keep the original first program listing 302 as an orientation landmark within the display area 112.

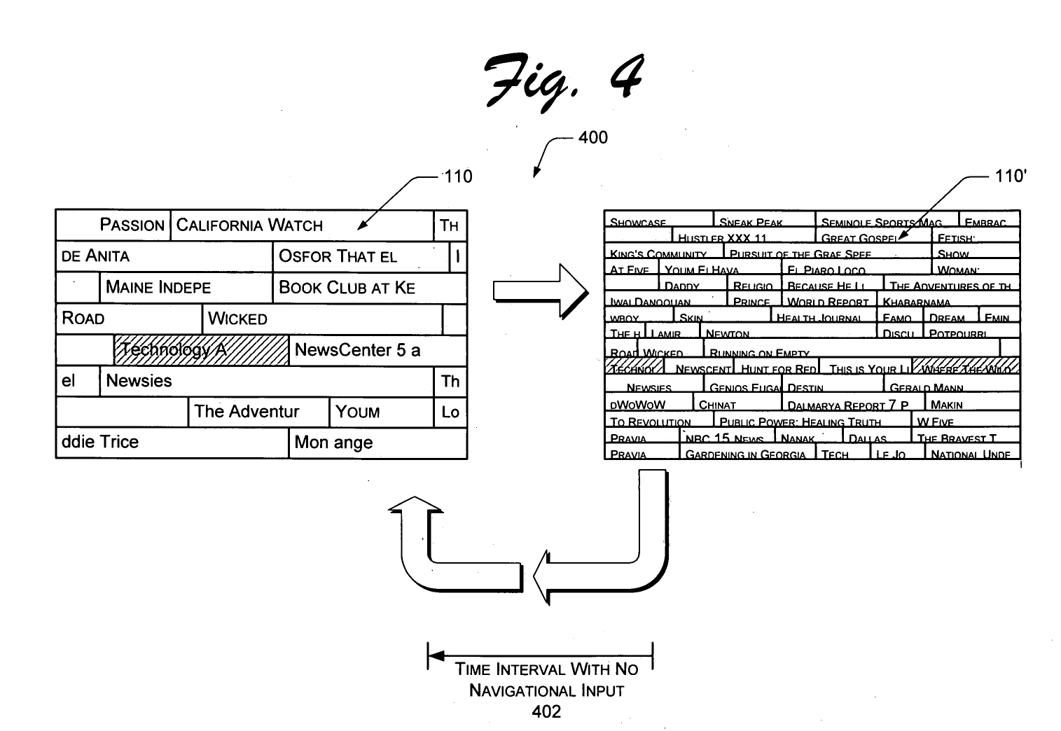

As shown in FIG. 4, using one exemplary technique 400, if displayed EPG information 110 has been rescaled (110′) in order to maintain simultaneous visibility of a first program listing 302 and a second program listing 304, then after a time interval 402 the rescaled displayed EPG information 110′ may automatically revert to a different scaling size (e.g., 110), but repositioned to maintain or return visibility of the second (currently focused) program listing 304.

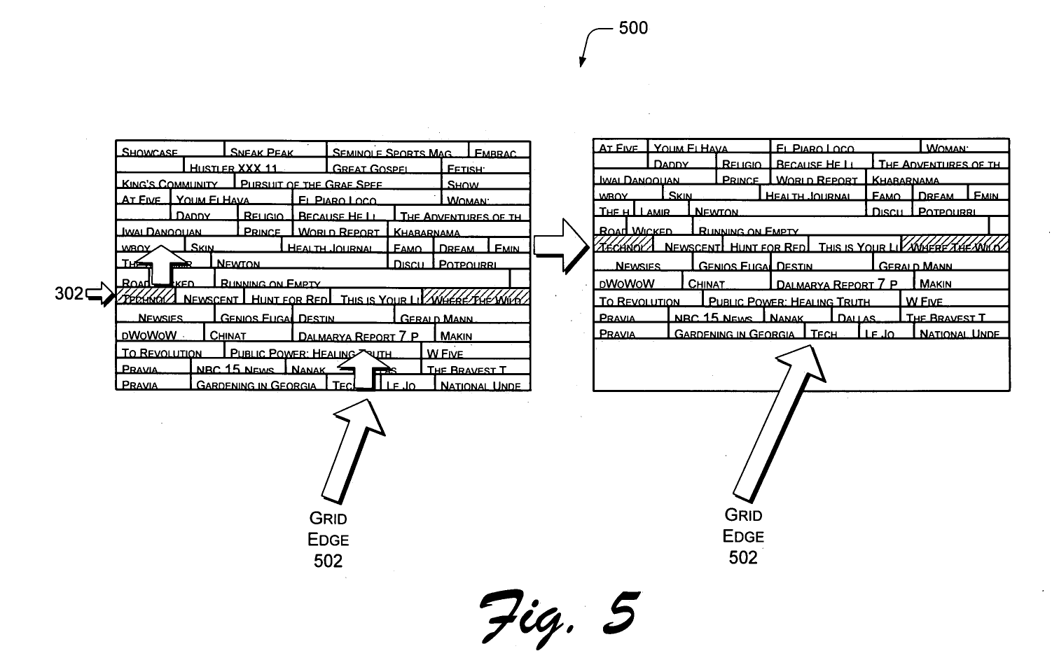

FIG. 5 shows an exemplary technique 500 for maintaining a visual landmark by displaying an edge of an EPG grid 102 within a display area 112, as noted above with respect to the grid edge tracking module 224 of FIG. 2. This exemplary technique 500 may be used separately or in addition to the exemplary technique 300 described with respect to FIG. 3.

When scrolling or browsing through an EPG grid 102, a focused program listing 302 is usually much smaller than the display area 112, and therefore there is usually some vertical and horizontal latitude regarding the exact location where the focused program listing 302 could be displayed within the display area 112. In this implementation, if the focused program listing is near a grid edge 502, but the grid edge 502 is not displayed in the display area 112, then the exemplary technique 500 moves and/or scales the displayed EPG information 110 relative to the display area 112 so that both the grid edge and the focused program listing 302 are visible. The exemplary technique 500 may be accomplished via a grid edge tracking module 224 of a navigation orientation engine 122.

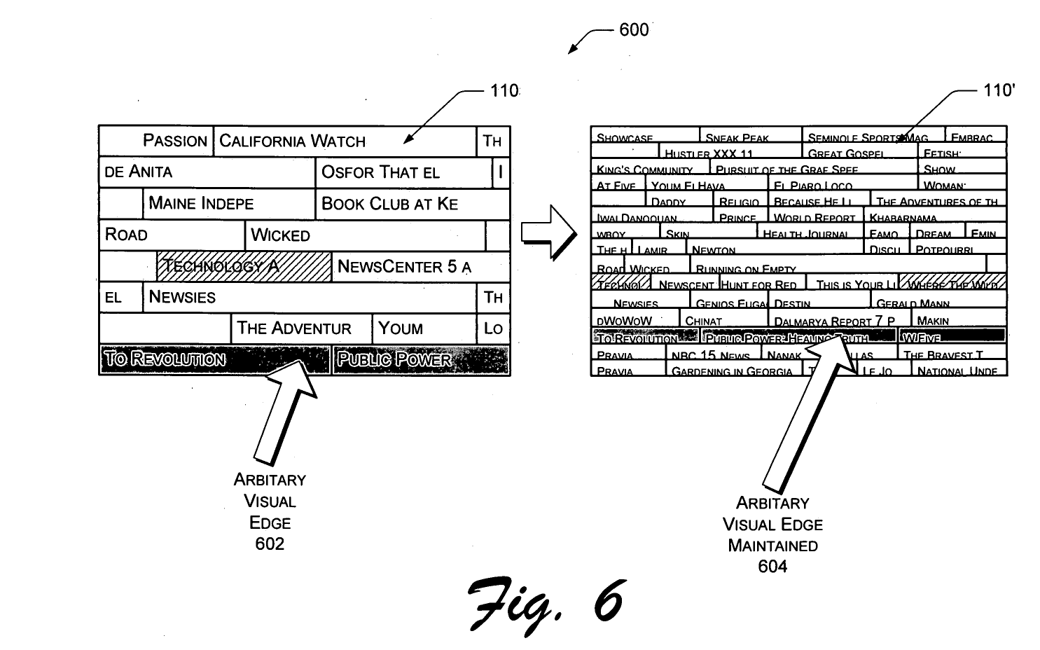

FIG. 6 shows an exemplary technique 600 in which a color, pattern, and/or design is added to or superimposed over the displayed EPG information 110 in order to provide one or more orientation landmarks for a user navigating the EPG grid 102. A visual landmark may be added by coloring or patterning one or more cells, columns, and/or rows of the displayed EPG information 110. For example, a landmark engine 216 can place an arbitrary visual edge 602 at a column or row in displayed EPG information 110 at one scaling size (110) and then when the displayed EPG information is rescaled (110′), the visual edge is maintained 604 despite its displacement, providing an orienting landmark.

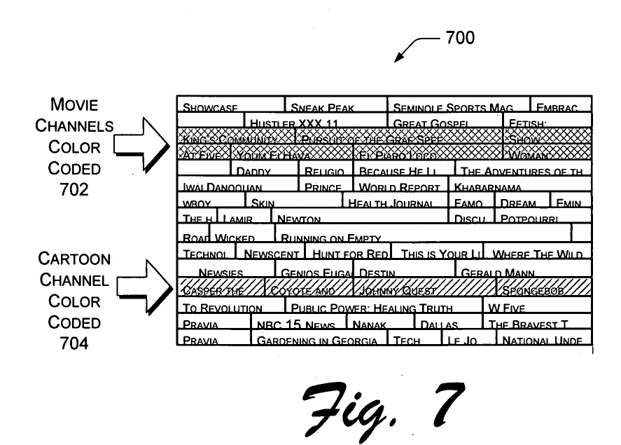

FIG. 7 shows another exemplary technique 700, in which similar channels or similar subject matter in the program listings are color coded instead of or in addition to one or more arbitrary visual edges 602. For example, movie channels 702 might be colored a first color and a cartoon channel 704 might be colored a second color. This provides vertical orientation when navigating a grid that has a vertical channel axis 104. In a variation, a color grid is placed over the entire displayed EPG information 110 and becomes magnified or reduced in proportion to the magnification or reduction of the displayed EPG information 110.

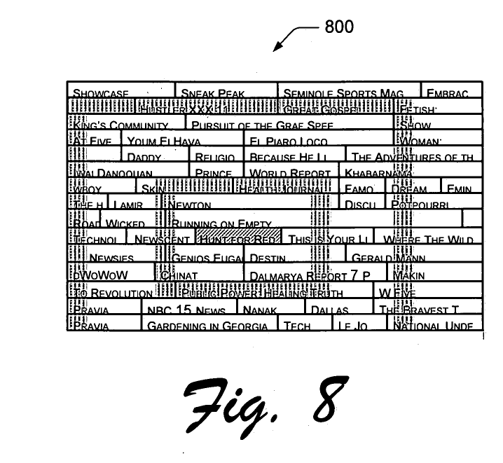

FIG. 8 shows another exemplary technique 800 in which an initially focused program listing is surrounded by “contour lines” composed of concentric color coded lines, circles, squares, etc., that each designate a milepost or scrolling distance from the initially focused program listing.

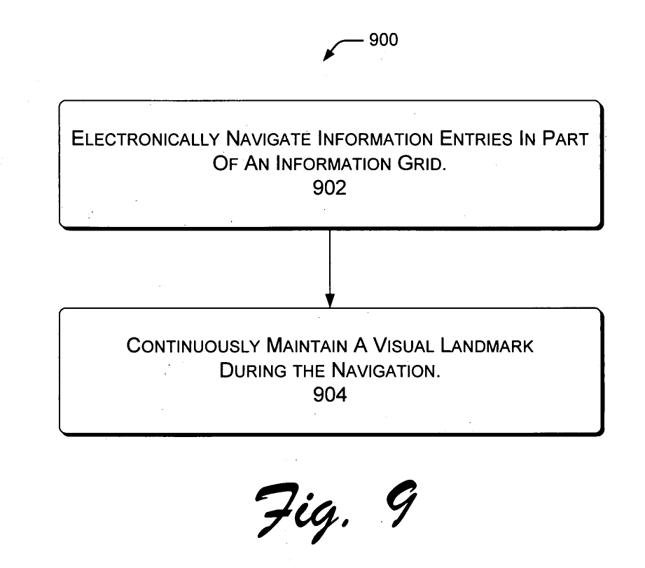

Exemplary Methods FIG. 9 is a flow diagram of an exemplary method 900 of electronically navigating an information grid. The exemplary method 900 can be performed by a module or engine, such as the exemplary navigation orientation engine 122 shown in FIG. 2. In the flow diagram, the operations are summarized in individual blocks. The operations may be performed in hardware and/or as machine-readable instructions (software or firmware) that can be executed by a processor.

At block 902, information entries in a two-dimensional information grid are electronically navigated in a display area that only reveals a part of the information grid at any one time.

At block 904, a visual landmark on the display is continuously maintained during the navigation.

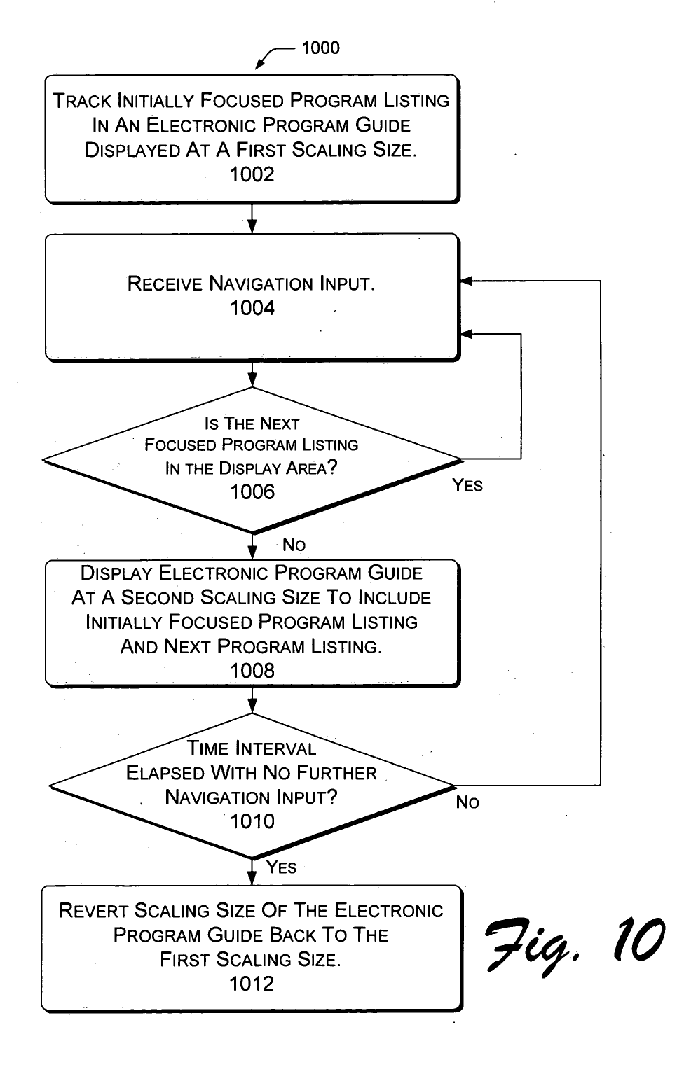

FIG. 10 is a flow diagram of an exemplary method 1000 of electronically navigating an information grid. The exemplary method 1000 can be performed by a module or engine, such as the exemplary navigation orientation engine 122 shown in FIG. 2. In the flow diagram, the operations are summarized in individual blocks. The operations may be performed in hardware and/or as machine-readable instructions (software or firmware) that can be executed by a processor.

At block 1002, an initially focused program listing of an electronic program guide is tracked as an initial starting point for navigation of the electronic program guide, wherein only a part of the electronic program guide is displayed at a first scaling size.

At block 1004, navigation input is received from directional navigation controls to focus a different program listing than the initially focused program listing.

At block 1006, if the navigation input focuses a next program listing that is included in the displayed part of the electronic program guide then the exemplary method 1000 branches back to block 1004, but if the navigation input focuses a second program listing that is not included in the displayed part of the electronic program guide then the exemplary method 1000 branches to block 1008.

At block 1008, if the navigation input focuses a next program listing that is not included in the displayed part of the electronic program guide then the electronic program guide is displayed at a second scaling size that displays both the initially focused program listing and the next program listing.

At block 1010, if more navigation input is received during a predetermined time interval, then the exemplary method 1000 branches back to block 1004, but if no more navigation input is received during the predetermined time interval then the exemplary method 1000 branches to block 1012.

At block 1012, if no more navigation input is received during the predetermined time interval then the scaling size of the electronic program guide reverts back to the first scaling size.

### CONCLUSION

It should be noted that the subject matter described above can be implemented in hardware, in software, or in both hardware and software. In certain implementations, the exemplary system, engine, and related methods may be described in the general context of computer-executable instructions, such as program modules, being executed by a television set-top box and/or by a computer. Generally, program modules include routines, programs, objects, components, data structures, etc. that perform particular tasks or implement particular abstract data types: The subject matter can also be practiced in distributed communications environments where tasks are performed over wireless communication by remote processing devices that are linked through a communications network. In a wireless network, program modules may be located in both local and remote communications device storage media including memory storage devices.

The foregoing discussion describes exemplary systems and methods for understandable navigation of a two-dimensional information array. Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method, comprising:
electronically navigating between entries in an information array, wherein a display shows only a part of the information array at a time; and
continuously maintaining a visual landmark on the display during the navigating.

2. The method as recited in claim 1, wherein the information array comprises a sequential list.

3. The method as recited in claim 1, wherein the information array comprises a two-dimensional grid.

4. The method as recited in claim 1, wherein the visual landmark shows a relation between a starting point for the navigating and an ending point for the navigating.

5. The method as recited in claim 1, further comprising dynamically scaling a size of the displayed part of the information array to maintain visibility of the visual landmark during the navigating.

6. The method as recited in claim 5, wherein the information array comprises a two-dimensional television electronic program guide grid and navigational input for the navigating is received only from four directional navigation keys.

7. The method as recited in claim 6, wherein the visual landmark maintained on the display is a program listing of the electronic program guide.

8. The method as recited in claim 7, wherein the program listing is the starting point for the navigating.

9. The method as recited in claim 8, wherein the navigating comprises scrolling using a means for directional navigating.

10. The method as recited in claim 9, wherein a current focus of the directional navigating is designated on the display.

11. The method as recited in claim 10, wherein the current focus is designated by highlighting a program listing in the electronic program guide grid.

12. The method as recited in claim 11, wherein the highlighting is accomplished by one of a color, a font characteristic, and a cursor.

13. The method as recited in claim 11, wherein the dynamic scaling is based on a scrolling distance between an initially focused program listing and a currently focused program listing.

14. The method as recited in claim 13, wherein scaling is applied in an amount to maintain visibility of the initially focused program listing and the currently focused program listing.

15. The method as recited in claim 14, wherein the scaling comprises applying different scaling sizes.

16. The method as recited in claim 15, wherein if a first scaling size is applied for an initially focused program listing and a second scaling size is applied to maintain visibility of both the initially focused program listing and a currently focused program listing, then further comprising reverting back to the first scaling size if no scrolling occurs during a predetermined time interval.

17. The method as recited in claim 15, wherein if a first scaling size is applied for an initially focused program listing and a second scaling size is applied to maintain visibility of both the initially focused program listing and a currently focused program listing, then further comprising changing the scaling size to allow program listings to be legible if no scrolling occurs during a threshold time interval.

18. The method as recited in claim 15, wherein the visual landmark is an edge of the electronic program guide grid.

19. The method as recited in claim 18, wherein the dynamic scaling is based on maintaining visibility of the edge of the electronic program guide.

20. The method as recited in claim 15, wherein a currently focused program listing is maintained in the same relative location within the display during dynamic scaling.

21. The method as recited in claim 15, further comprising adding a visual landmark to the electronic program guide grid.

22. The method as recited in claim 21, wherein the visual landmark is a colored cell of the electronic program guide grid.

23. The method as recited in claim 21, wherein the visual landmark is one of a colored row and a colored column of the electronic program guide grid.

24. The method as recited in claim 21, wherein the visual landmark is contour lines added around the initially focused program listing.

25. The method as recited in claim 24, wherein the contour lines are formed by adding one of a color, a pattern, and a design to cells of the electronic program guide grid.

26. The method as recited in claim 5, further comprising:
using a disproportionately large text font for display of an entry in the information array, wherein each displayed entry in the information array is allotted an associated reduced display area in response to the dynamic scaling; and truncating a part of the entry to fit into its associated reduced display area.

27. The method as recited in claim 26, further comprising if the entry comprises text, then truncating a part of the bottom half of the entry to fit the entry into its associated reduced display area.

28. The method as recited in claim 1, wherein navigational input for the navigating is received from one of a trackball, a joystick, a direction button on a remote controller, a trackball, a game-rocker pad, or a joystick.

29. A navigation orientation engine, comprising:
a display area generator to produces a visual window displaying part of an information grid having information entries, wherein the display area generator determines the part of the information grid to display;
a focus controller communicatively coupled with the display area generator to receive directional navigation input for changing navigational focus between information entries;
included in the display area generator, a means for scaling the part of the information grid for display by selecting the size of the part, wherein if a relatively small part of the information grid is selected then the displayed information appears relatively large when displayed and if a relatively large part of the information grid is selected then the displayed information appears relatively small when displayed; and
one or more focus tracking modules to track an initially focused information entry and a currently focused information entry, wherein the means for scaling changes the size of the part of the information grid to be displayed to continuously retain the visibility of the initially focused information entry and the currently focused information entry.

30. The navigation orientation engine as recited in claim 29, further comprising a grid edge tracking module to reposition the displayed part of the information grid to display a grid edge.

31. The navigation orientation engine as recited in claim 29, further comprising a timer to time an interval wherein if no navigational input is received, then if the information grid is scaled to an illegible scale then the scaling sizer rescales the information grid to a legible scale.

32. The navigation orientation engine as recited in claim 29, further comprising a landmark engine to generate visual orientation cues for the information grid.

33. The navigation orientation engine as recited in claim 32, further comprising a color module to add color to the display of selected information entries as a navigation landmark.

34. The navigation orientation engine as recited in claim 33, wherein the color is added as contour markings around the initially focused information entry.

35. The navigation orientation engine as recited in claim 29, further comprising a truncation module to display an information entry in a font size disproportionately large in relation to a scale of the information grid, wherein the text of an information entry having the font size is truncated to fit in a grid cell of the information grid.

36. The navigation orientation engine as recited in claim 29, further comprising a truncation module to display an information entry in a font size disproportionately large in relation to a scale of the information grid, wherein the bottom portion of an information entry text having the font size is truncated to fit in a grid cell of the information grid.

37. One or more computer readable media containing instructions that are executable by a computer to perform actions comprising:
receiving navigation instructions for browsing program listings in a displayed portion of an electronic program guide;
keeping track of a navigation starting point and a navigation current focus; and
sizing the displayed portion to keep the navigation starting point and the navigation current focus continuously visible.

38. The one or more computer readable media as recited in claim 37, further comprising instructions to:
revert the sizing of the displayed portion to a legible scale if navigation ends and the program listings are illegible.

39. The one or more computer readable media as recited in claim 37, further comprising instructions to:
use a disproportionately large font in the displayed portion if program listings in the displayed portion are illegible due to the sizing; and
truncate the ends of program listings text to fit grid cells in the electronic program guide.

40. The one or more computer readable media as recited in claim 37, further comprising instructions to:
use a disproportionately large font in the displayed portion if program listings in the displayed portion are illegible due to the sizing; and
truncate the bottoms of program listings text to fit grid cells in the electronic program guide.
